(19) United States
(12) Patent Application Publication
(10) Pub. No.: US 2011/0305807 A1
(43) Pub. Date: Dec. 15, 2011

(54) SYSTEM FOR PREPARING A BEVERAGE SUITABLE FOR CONSUMPTION, AND EXCHANGEABLE HOLDER FOR SUCH SYSTEM

(75) Inventors: Hendrik Cornelis Koeling, Amersfoort (NL); Gerbrand Kristiaan De Graaff, Lisse (NL); Gustaaf Frans Brouwer, Nijkerk (NL)

(73) Assignee: Sara Lee/De N.V.

(21) Appl. No.: 12/297,629

(22) PCT Filed: Apr. 19, 2007
(86) PCT No.: PCT/NL07/50164

§ 371 Date: Jan. 14, 2009

(30) Foreign Application Priority Data
Apr. 19, 2006 (NL) 1031622

(51) Int. Cl. A47J 31/41; A23L 2/385

(52) U.S. Cl. 426/431; 99/283

(57) ABSTRACT

A system (1) for preparing a predetermined amount of beverage suitable for consumption, provided with an exchangeable holder (2) and an apparatus (4) provided with a fluid dispensing device (6) which is detachably connected to the holder (2) for dispensing at least an amount of at least a first fluid, such as water, under pressure to the exchangeable holder (2), wherein the exchangeable holder (2) is provided with at least one storage space (8) which is filled with a second fluid, such as a concentrate.

The invention relates to a system for preparing a predetermined amount of beverage suitable for consumption, provided with an exchangeable holder and an apparatus provided with a fluid dispensing device which is detachably connected to the holder for dispensing at least an amount of at least a first fluid, such as a liquid and/or a gas, in particular such as water and/or steam, under pressure to the exchangeable holder, while the exchangeable holder is provided with at least one storage space which is filled with a second fluid, such as a concentrate.

The invention further relates to an exchangeable holder designed to be connected to an apparatus provided with a fluid dispensing device for dispensing at least a first fluid, such as a gas and/or liquid, under pressure, to the exchangeable holder for preparing a beverage suitable for consumption, the exchangeable holder being provided with at least one storage space filled with a second fluid, such as a concentrate.

The invention further relates to a method for preparing a beverage suitable for consumption.

Such a system and such an exchangeable holder are known per se.

With the known system, the apparatus is provided with, for instance, a needle which, in use, is pierced through a wall of the storage space for supplying the first fluid to the storage space. In the storage space, the first fluid and the second fluid mix together so that the beverage suitable for consumption is obtained which, thereupon, can flow from the apparatus to be consumed/for consumption.

A drawback of the known system is that the strength of the amount of beverage that is dispensed can vary in an uncontrolled manner. The fact is that if, at the start of the preparation of the beverage, the storage space still comprises relatively much of the second fluid, the beverage leaving the exchangeable holder will comprises a relatively high concentration of the second fluid and a relatively low concentration of the first fluid. By contrast, at the end of the preparation cycle, the beverage that flows from the holder will comprise a relatively low concentration of the second fluid and are relatively high concentration of the first fluid. Further, with the known system, it is not possible to vary the properties of the beverage in a user-friendly manner, other than by varying the type of first fluid, the type of second fluid and/or the amount of the first fluid or the second fluid. The object of the invention is to provide a system with which, if desired, the above-mentioned drawbacks can be prevented and, furthermore, other advantages can be realized.

Accordingly, the system according to the invention is characterized in that the holder is further provided with at least a first mixing chamber, at least one outflow opening which is in fluid communication with the first mixing chamber for dispensing the beverage from the first mixing chamber, at least one fluid communication between the storage space and the first mixing chamber for dispensing the second fluid to the first mixing chamber and at least one inlet opening which is detachably connected to an outlet opening of the fluid dispensing device for supplying the first fluid to the first mixing chamber, the system further being provided with a dosing device designed for supplying the second fluid in a dosed manner from the storage space to the first mixing chamber by supplying a third fluid, such as a gas or a liquid, in a controlled manner, under pressure, to the second fluid in the storage space (so that the third fluid applies a pressure and/or force to the second fluid), while the fluid dispensing device is designed for supplying the first fluid under pressure to the first mixing chamber, so that in the first mixing chamber the first fluid and the second fluid mix together for obtaining the beverage which, then, leaves the exchangeable holder via the outflow opening. Mixing can also be understood to mean, for instance, that the second fluid dissolves in the first fluid or that the second fluid is diluted by the first fluid.

As presently, the second fluid is dispensed in a dosed manner from the storage space to the first mixing chamber, the concentration of the second fluid in the beverage leaving the first mixing chamber can be accurately regulated. The fact is that the second fluid is dispensed to the first mixing chamber in a dosed manner. The first fluid too can be dispensed in a dosed manner by the fluid dispensing device to the first mixing chamber, so that, consequently, the properties of the beverage formed by mixing the first fluid and the second fluid in the first mixing chamber can be well determined. Through controllable supply, under pressure, of a third fluid to the second fluid in the storage space, it applies that the dosing device is a controllable, active dosing device for supplying the second fluid to the first mixing chamber, through application of an increased pressure or force to the second fluid. Supplying the second fluid to the first mixing chamber can then be regulated at will. When supplying the third fluid under pressure to the storage space, the third fluid will apply a pressure and/or force to the second fluid. As a result, the third fluid will be forced via the fluid communication to the first mixing chamber. In use, the third fluid will effectively urge the second fluid from the storage space to the first mixing space. Then, the second fluid is pressed or urged from the storage space by the third fluid.

Here, it holds in particular that the system is further provided with a control device for controlling the dosing device and the fluid dispensing device. The dosing device and the fluid dispensing device can, for instance, be controlled independently of each other by the control device.

More in general, it holds that the system is designed such that the fluid dispensing device and the dosing device can supply the first fluid and the second fluid, respectively, to the first mixing chamber, independently of each other. In this manner, the preparation of the beverage can be varied as desired by regulating the amount and the period of supply of the first and second fluid, independently of each other.

The third fluid can comprise, for instance, a gas and/or liquid. With the aid of, for instance, the gas, the storage space can be blown out well. The gas will then remain in the storage space above the second fluid so that through supply of more gas to the storage space, the second fluid is forced from the storage space. If, after use, the holder is removed from the system, the gas can, if necessary, can escape from the holder in a simple manner.

Instead of a gas, the third fluid can, as stated, also be a liquid. If, for instance the second fluid is also a liquid and, for instance, the specific weight of the liquid of the third fluid is lower than that of the second fluid, the third fluid, when supplied above the second fluid to the storage space, can effectively urge the second fluid in downward direction from the storage space, to the first mixing chamber. It may also be so that the second and third fluids have the property that they do not mix well. In the storage space, the third fluid will, as a rule, remain above the second fluid. It may also happen that apart from the second fluid, the third fluid enters into the first mixing chamber too, which is not a problem when the third fluid is, for instance, a gas or a liquid that can be incorporated in the beverage. The second fluid and the third fluid are such that the third fluid can urge the second fluid from the (respective) storage space.

Preferably, the system can be provided with a needle which, in use, is pierced through a wall of the holder, more particularly through a wall of the storage space or through a wall of the holder at a position below which there is a space which is in fluid communication with the storage space, for supplying the third fluid to the second fluid in de storage space. Piercing with such a needle is reliable and can be controlled in a simple and reliable manner. The needle can cooperate with an at least locally weakened area of a wall of the storage space for, in use, piercing the needle through this area. For instance, a hollow needle can be used through which the third fluid can flow. The needle can also be encapsulated by a sealing tube or the like in order to realize a sealing between the needle and the wall through which the needle has been pierced.

Preferably, it further holds that the system is further provided with a restriction, included in a fluid flow path which extends, via the outlet opening of the fluid dispensing device, the inlet opening of the holder and the first mixing chamber, from the fluid dispensing device to the outflow opening. With the restriction, for instance a jet and/or mist can be generated.

It may also preferably hold that the system is further provided with a restriction which is included in a fluid flow path which extends, via the outflow opening and the inlet opening, from the fluid dispensing device to the first mixing chamber. Here it holds, for instance, that the restriction is designed such that, in use, with the restriction, a jet of the first fluid is generated which spouts into the first mixing chamber. As a result, the first and the second fluid can mix together well in the first chamber.

In particular, it holds that the system is further provided with at least one air inlet opening for supplying air to the first mixing chamber so that, in use, air is whipped into the beverage for obtaining a beverage with a fine bubble froth layer. According to a preferred embodiment, it holds here that the air inlet opening forms part of the holder. As the air inlet opening forms part of the exchangeable holder, per exchangeable holder, for instance, a size of the air inlet opening may be determined in advance in order to determine, per exchangeable holder, how much air is whipped into the beverage. Depending on the type of beverage that is to be prepared, the size of the air inlet opening can be determined. If the second fluid is, for instance, a coffee concentrate and the first fluid is, for instance, water, while it is intended that coffee with a small fine bubble froth layer is prepared, the size of the air inlet opening can be selected to be relatively small. If by contrast, the exchangeable holder is filled with a second fluid in the form of for instance a milk concentrate, while the first fluid is, once more, water, while it is intended that the beverage consist of frothed milk, the air inlet opening can be relatively large. As, in this example, the air inlet opening forms part of the exchangeable holder, the consumer needs not set anything. All this can be optimized in advance by the manufacturer.

In particular, it further holds that the restriction forms part of the holder. In this manner too, if desired, depending on the type of beverage that is to be prepared, and, in this example, for instance, depending on the type of second fluid present in the storage space, the size of the restriction can be determined in advance. If the restriction is for instance relatively small, a relatively strong jet of, for instance, water can be generated. Such a relatively strong jet may be desired when the second fluid comprises, for instance, of concentrate with a high viscosity. Here, due to the relatively strong jet of the first fluid, the concentrate will dissolve well in the first fluid or be well diluted with the first fluid. In this manner, it can be effected too that in the first mixing chamber, a relatively strong turbulence is formed of the liquids present there so that, when the air inlet opening is present, relatively much air is whipped into the beverage. It is therefore of advantage when the restriction forms part of the exchangeable holder.

According to an advanced embodiment, it holds that the exchangeable holder is provided with a plurality of storage spaces, separated from each other, which are each filled with a second fluid. For instance, a first storage space can be filled with a coffee concentrate while a second storage space is filled with a milk concentrate. In this manner, coffee with milk can be prepared when the first fluid comprises, for instance, water. In particular it holds that the dosing device is designed for supplying the second fluids in a dosed manner from the storage spaces to the first mixing chamber through supply of the third fluid, in a controllable manner, under pressure, to the second fluids in the storage spaces. In particular, it holds here that the dosing device is designed for supplying the third fluid to the second fluids in the storage spaces independently, per storage space. As a result, per storage space, an individual dosing of the second fluid to the first mixing chamber can be carried out.

It further holds according to this preferred embodiment, that the dosing device is, in fact, provided with a plurality of dosing devices for dispensing, with different dosing devices, the second fluids in a dosed manner to the first mixing chamber, from mutually different storage spaces.

In this manner, for instance, first, from a first storage space, a coffee concentrate can be supplied to the first mixing chamber while, the fluid dispensing device can supply the liquid in the form of, for instance, hot water to the first mixing chamber for preparing coffee. Then, from the second storage space, milk concentrate is supplied in a dosed manner to the first mixing chamber while, also, the hot water is supplied to the first mixing chamber. Here, when further, an air inlet opening is present, air can be whipped in so that frothed milk is obtained. This frothed milk is then dispensed from the exchangeable holder. In this manner, when the coffee, and then, the frothed milk are captured in the same mug, a good cappuccino can be prepared with a white froth layer formed by hot milk. The system, more in particular the holder, can also be provided with an adjustable air inlet opening. Here, for instance, when dosing the milk concentrate, the air inlet opening can be opened for obtaining frothed milk as discussed hereinabove. When dosing the coffee concentrate, the air inlet opening can be closed for obtaining coffee comprising virtually no froth. The coffee and the frothed milk can then be combined as discussed hereinabove for obtaining a cappuccino as described hereinabove.

According to an advanced embodiment, it holds that between each storage space on the one side and the first mixing chamber on the other side, a seal is present which will open when the pressure applied by one of the fluids to the seal increases to above a particular value. In particular, here, at least a number of the seals will open at mutually different pressures. First, for instance, at least one seal will open when the pressure in the respective storage space rises to above a particular value belonging to the respective seal. At least a number of other seals will then not open yet. The result is that at the at least one seal that opens first, the second fluid can flow away to the mixing chamber so that in the first mixing chamber, under the influence of the liquid, a beverage can be generated. At a somewhat later moment, at least one of the other seals will open so that then, from the associated storage space, the respective second fluid can be dispensed to the first mixing chamber for preparing a different beverage. In this manner, first, for instance coffee can be formed and then milk, in particular frothed milk, while, first, the coffee can flow from the first mixing chamber into a container, such as a cup, whereupon the frothed milk can flow from the first mixing chamber into the cup so that at least the froth of the milk will float on the coffee resulting in the formation of an attractive cappuccino with white froth.

More in general, it holds that the system is designed for dispensing fluids at mutually different flow rates and/or during mutually different periods, with at least two different dosing devices from at least two storage spaces. Here, the dosing devices can, once more, operate or be controlled independently of the fluid dispensing device. In other words, the first fluid and the second fluids can be controllably dispensed, at mutually different flow rates and/or within mutually different periods of time.

The at least one air inlet can form part of the apparatus or the holder. In particular, it applies that the at least one air inlet is provided with an adjustable valve for adjusting the size of the air flow. The valve can be regulated both by the apparatus and by the consumer (manually). The valve can be set depending on, for instance, the type of beverage that is to be prepared. For instance, the exchangeable holder can be provided with a code, readable by the apparatus, so that the apparatus knows which type of beverage is to be prepared and thus, the apparatus can set, for instance, the adjustable valve and/or the fluid dispensing device for determining, for instance, the pressure, the amount and the temperature of the liquid which is supplied to the exchangeable holder.

The holder according to the invention is characterized in that the holder is further provided with at least a first mixing chamber, at least one outflow opening which is in fluid communication with the first mixing chamber for dispensing the beverage from the first mixing chamber, at least one fluid communication between the storage space and the first mixing chamber for dispensing the first fluid to the first mixing chamber and at least one inlet opening which, in use, is detachably connected to an outflow opening of the fluid dispensing device for supplying the second fluid to the first mixing chamber, while the storage space forms part, at least partly, of a dosing device, while the holder is designed such that, in use, a third fluid can be supplied, with the apparatus, in a controllable manner, under pressure, to the second fluid in the storage space (so that the third fluid applies a pressure and/or force to the second fluid) for dispensing the second fluid in a dosed manner from the storage space to the first mixing chamber while, in use, the first fluid is also supplied under pressure to the first mixing chamber, so that the second fluid and the first fluid mix together for obtaining the beverage which, then, leaves the holder via the outflow opening.

In particular, it holds here that the holder is provided with means cooperating with the apparatus for supplying, in use, the third fluid with the apparatus to the second fluid in the storage space, while the means cooperating with the apparatus comprise, for instance, at least one locally weakened area of a wall of the storage space for piercing, in use, this area with a needle of the dosing device, for supplying the third fluid to the second fluid in the storage space.

The means cooperating with the apparatus can comprise, for instance, at least one locally weakened area of a wall of the storage space for, during use piercing a needle of the dosing device through this area, for supplying the third fluid to the second fluid in the storage space. However, other means cooperating with the apparatus are possible too, for instance a valve in a wall of the storage space, which valve cooperates with a supply duct of the dosing device connectable to the valve, for supplying the third fluid to the second fluid in the storage space. The walls of the storage spaces can be at least partly rigid and/or at least partly flexible. It is preferred that flexible parts of the walls are not stretchable, so that the storage spaces for supply of the third fluid are not inflated. By contrast, upon supply of the third fluid, the storage space can bulge somewhat, while upon further supply, the second fluid is forced from the storage space as discussed hereinabove.

The invention will presently be further specified on the basis of the drawing.

In the drawing:

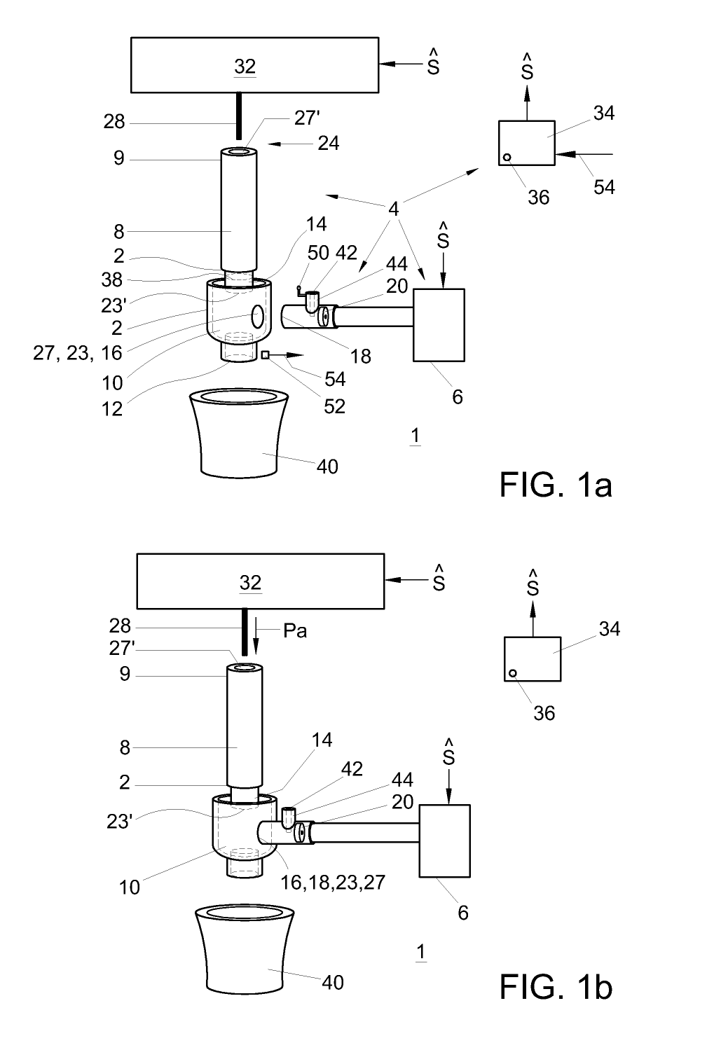

FIG. 1a shows a first embodiment of a system according to the invention provided with a holder according to the invention;

FIG. 1b shows the system according to FIG. 1a in operational condition;

FIG. 1c shows the system according to FIG. 1a in operational condition;

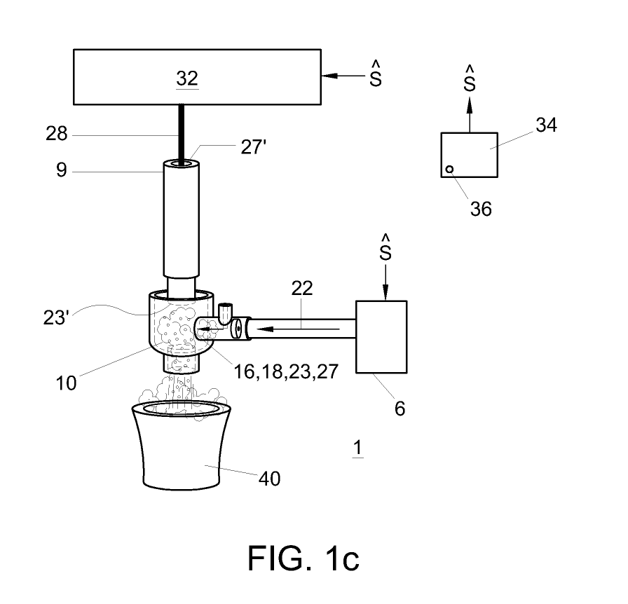

FIG. 2a shows a cross-section of a second embodiment of a system according to the invention provided with a holder according to the invention;

FIG. 2b shows a partly cutaway side view of the holder of FIG. 2a;

FIG. 2c shows a cross-section of the holder according to FIG. 2a;

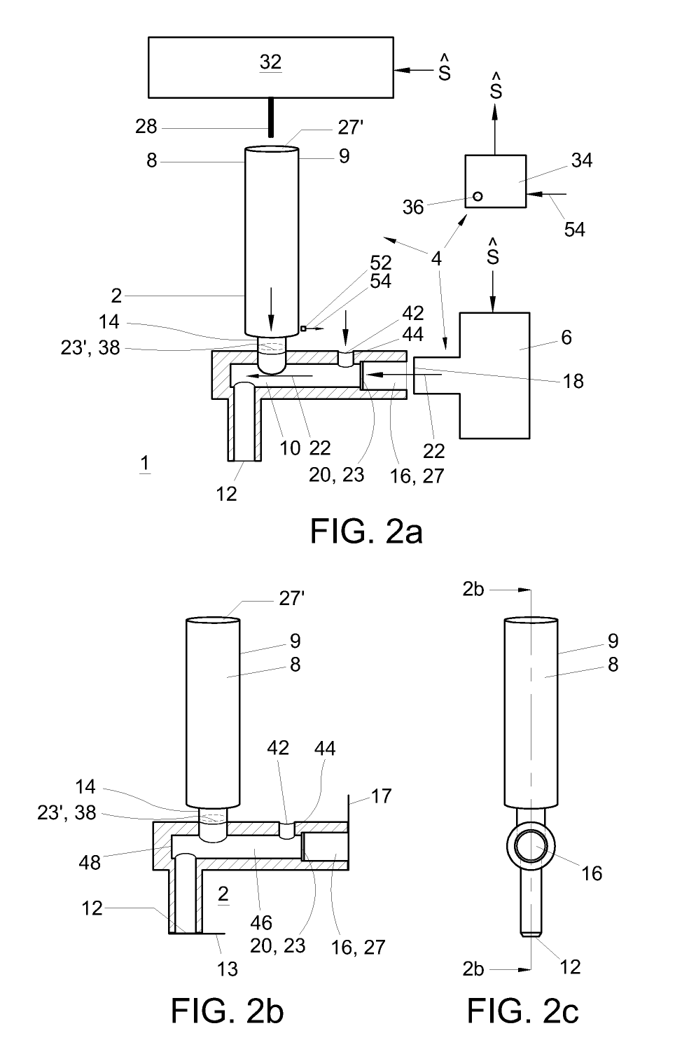

FIG. 3a shows a third embodiment of a system according to the invention provided with a holder according to the invention;

FIG. 3b shows a cross-section of a part of the holder according to FIG. 3a;

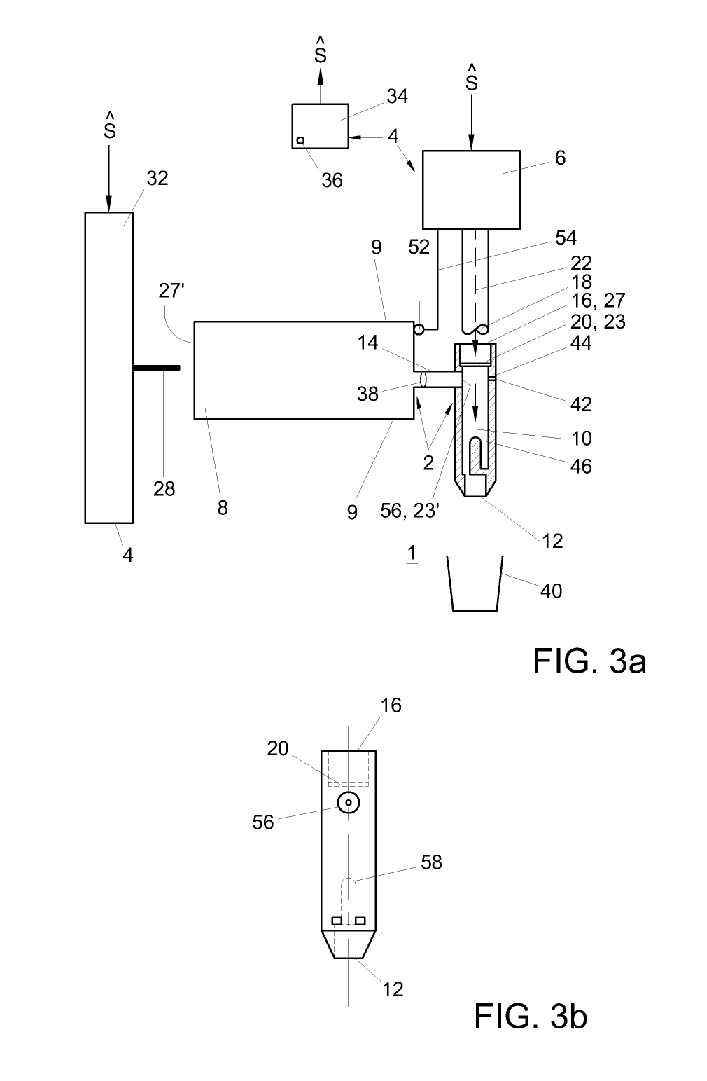

FIG. 4a shows a fourth embodiment of a system according to the invention;

FIG. 4b shows a cross-section of the storage space of the holder according to FIG. 4a;

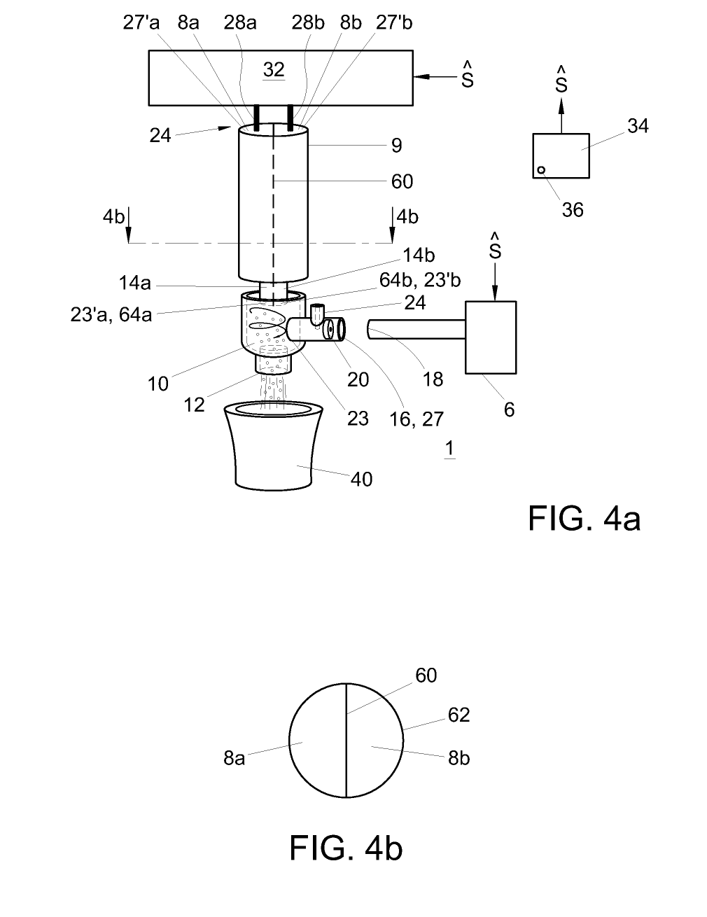

FIG. 5a shows a fifth embodiment of a system according to the invention;

FIG. 5b shows a cross-section of the fluid communication of the holder according to FIG. 5a;

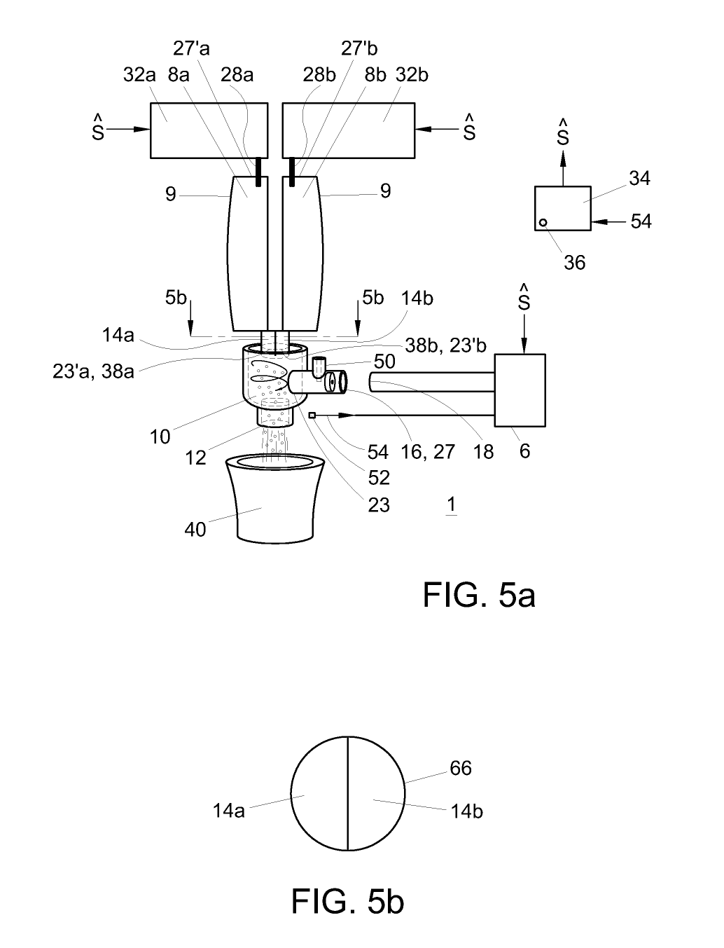

FIG. 6a shows a sixth embodiment of a system according to the invention;

FIG. 6b shows a cross-section of the fluid communication of the holder according to FIG. 6a;

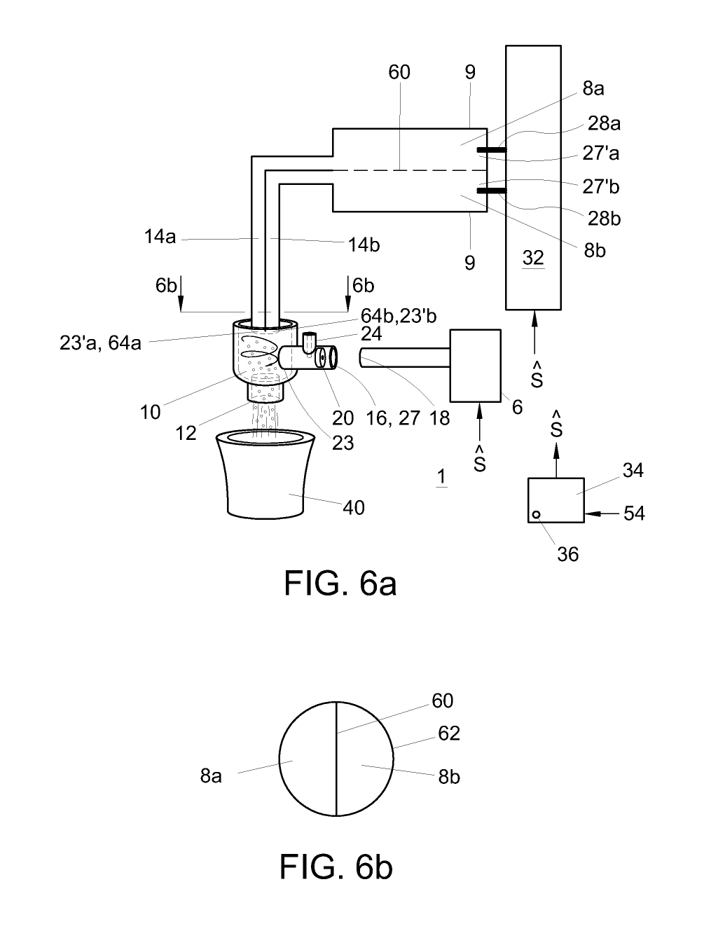

FIG. 7 shows a seventh embodiment of a system according to the invention.

In FIG. 1, reference numeral 1 indicates a system for preparing a predetermined amount of beverage suitable for consumption. The system (see FIG. 1a) is provided with an exchangeable holder 2 and an apparatus 4 provided with, inter alia, a fluid dispensing device 6 designed for dispensing, under pressure, at least one amount of at least a first fluid, such as a liquid and/or a gas, more particularly such as water and/or steam. In this example, in use, the fluid dispensing device dispenses water.

The exchangeable holder 2 is provided with at least one storage space 8 which is filled with a second fluid such as a beverage, a concentrate or a powder. In this example, the storage space is formed by a rigid wall. This is, however, not necessary. In this example, a concentrate for preparing coffee is concerned. The holder 2 is further provided with at least a first mixing chamber 10 an at least one outflow opening 12 which is in fluid communication with the first mixing chamber 10. The holder is further provided with a fluid communication 14 between the storage space 8 and the first mixing chamber 10. The holder is further provided with at least one inlet opening 16 which is detachably connected to an outflow opening 18 of the fluid dispensing device 6. In FIG. 1a, the inlet opening 16 has not yet been connected to the outlet opening 18. This is, however, the case in FIG. 1b. In this example, the inlet opening in FIG. 1a is still sealed off a by a closure which can be removed, such as a removable seal. This also applies for the outflow opening 12. In use, both removable seals are removed, whereupon the outlet opening 18 can be connected to the inlet opening 16 as shown in FIG. 1b.

In this example, the system is further provided with a restriction 20 which is included in a fluid flow path 21 which extends, via the outlet opening 18 of the fluid dispensing device 6, the inlet opening 16 and the first mixing chamber 10, from the fluid dispensing device 6 to the outflow opening 12.

More particularly it applies in this example that the restriction 20 is included in a fluid flow path 22 which extends, via the outflow opening 18 of the fluid dispensing device 6 and the inlet opening 16 of the exchangeable holder 2, from the fluid dispensing device to the first mixing chamber 10.

The storage space 8 forms at least a part of a dosing device as will be explained in further detail hereinbelow. In this example, this dosing device 24 is further provided with a needle 28 which, in use, is pierced through a wall of the storage space for supplying a third fluid to the second fluid in the storage space for dispensing the second fluid to the first mixing chamber in a dosed manner. The dosing device 24 is further provided with a fluid dispensing unit 32 which is connected to the needle 28. The fluid dispensing unit 32 and the needle 28 form part of the apparatus 4. The fluid dispensing device 32 is, in this example at least via the needle 28, detachably connectable to the holder 2.

The apparatus 4 is further provided with a control device 34 for controlling the fluid dispensing device 6 and the fluid dispensing unit 32. For controlling the fluid dispensing device 6 and the fluid dispensing unit 32, the control device 34 generates control signals ŝ which are supplied to the fluid dispensing device 6 and the fluid dispensing unit 32. The apparatus described heretofore works as follows. For the purpose of preparing a predetermined amount of beverage suitable for consumption, the exchangeable holder 2 is placed in the apparatus. Here, the storage space 8 of the exchangeable holder is placed under the needle 28. Also, as shown in FIG. 1b, the outflow opening 18 is connected to the inlet opening 16. The apparatus is now ready for use. By pushing, for instance, a button 36 of the control device 34, the control device provides for the fluid dispensing unit 32 to start moving the needle 28 in the direction of the arrow Pa. The result hereof is that the needle 28 is pierced through a wall of the storage space 8 and the third fluid is supplied under pressure to the second fluid in the storage space. As a result, the third fluid will apply a pressure and/or force to the second fluid. In this example, this results in the increase of the pressure in the storage space. The second fluid is thus pressurized with the pressure of the third fluid. The third fluid can consist of, for instance, air, nitrogen, oxygen, CO₂, helium and the like. It is also conceivable that the third fluid consists of a liquid that does not mix with the second fluid. The fluid communication 14 can then be further provided with, for instance, a seal 38, in the form of, for instance, a breakable skin 38 which, as a result of the increase of the pressure in the storage space 8 caused by the supply of the third fluid, tears open. As a result, in this example, the coffee concentrate will flow in a dosed manner form the storage space 8 via the fluid communication 14 to the first mixing chamber 10. Simultaneously, the control device 34 provides for the fluid dispensing device 6 to be activated. This results in that the fluid dispensing device 6 starts dispensing the first fluid under pressure, in this example water. In this example, this water is hot water with a temperature of, for instance, 80-98° C. This hot water flows via the liquid flow path to the restriction 20. Having arrived at the restriction 20, by means of the restriction 20, a jet of the hot water is generated. This jet spouts via the outflow opening 18 and the inlet opening 16 into the first mixing chamber 10. It will be clear that in the example of FIGS. 1a and 1b, the first mixing chamber 10 comprises a first entrance opening 23 and a second entrance opening 23′ placed at a distance from the first entrance opening, while, in use, the first fluid enters the first mixing chamber via the first entrance opening and the second fluid enters the first mixing chamber via the second entrance opening. In this example, the inlet opening 16 is in fluid communication with the first entrance opening 23. In this example, the fluid communication 14 terminates in the second entrance opening 23′.

It will also be clear that in the example of FIGS. 1a and 1b, the holder 2 comprises a first supply location 27 and a second supply location 27′ located at a distance from the first supply location, while, in use, the first fluid is supplied to the holder 2 at the first supply location and the third fluid is supplied to the holder at the second supply location. In this example, the inlet opening 16 is located at the first supply location 27. In this example, the second supply location 27′ is in fluid communication (or can be brought in fluid communication) with the storage space 8.

In the first mixing chamber 10, the hot water will start mixing well with the concentrate. Here, the flow rate at which the concentrate is supplied to the mixing chamber is regulated by the control device 34 through control of the fluid dispensing unit 32. Further, the flow rate at which the hot water is supplied to the first mixing chamber is also regulated by the control device through control of the fluid dispensing device. In the first mixing chamber, as a result of the jet, the concentrate will mix well with the hot water so that the beverage is formed. This beverage can then leave the outflow opening 12 and be captured in, for instance, a mug 40. As, with the system according to the invention, both the dosing of the concentrate over time and the dosing of the hot water over time can be regulated well, it can be ensured that the concentration of the amount of concentrate in the beverage can be accurately determined. Furthermore, it can be ensured that the beverage which, during its preparation, leaves the outflow opening 12 is of constant quality, i.e., the concentration of the concentrate in the beverage that is dispensed can be kept constant during dispensing, if desired. The fact is that the flow rate of the water and the flow rate of the concentrate supplied to the first mixing chamber 10 can each, if desired, be controlled independently of each other. It therefore holds more generally that the system is designed such that the fluid dispensing device and the dosing device can, independently of each other, supply the first fluid and the second fluid, respectively, to the first mixing chamber. This entails that the size of the flow rate of the first fluid and the period during which the first fluid is dispensed, are independent (in this example through control of the control device) of the size of the flow rate of the second fluid and the period during which the second flow rate is dispensed.

It further holds that the dosing device concerns a controllable and active dosing device for supplying the second fluid to the first mixing chamber through application of an increased pressure or force to the second fluid. Here, an active dosing device is understood to means that the second fluid flows through the fluid communication from the storage space to the first mixing chamber as a result of an applied excess pressure or force on the side of the storage space. By dosing the supply of the third fluid to the storage space, a dosing of the supply of the second fluid from the storage space to the mixing chamber is obtained.

In the example, the system is further provided with an air inlet opening 42. The air inlet opening 42 ensures the supply of air to the first mixing chamber so that, in use, air is whipped into the beverage for obtaining a beverage with a fine bubble froth layer. Thus, a café crème can be obtained. The air inlet opening 42 is, in this example downstream of the restriction 20, in fluid communication with the first mixing chamber 10. In this example, the air inlet opening 42 terminates via a fluid communication 44 into the fluid flow path 22. In each example it therefore holds that the air inlet opening and the restriction 20 each form part of the apparatus 4.

After the beverage, in this example coffee with a fine bubble froth layer, has been prepared, the control device 34 stops the fluid dispensing device 6. The control device 34 also ensures that the third fluid is no longer supplied to the second fluid in the storage space and that the needle 28 is withdrawn from the respective wall of the storage space, i.e. in a direction opposite the direction of the arrow Pa. Here, it may be so that first, the control device ensures that the dispensing of the second fluid to the first mixing chamber is stopped and that after that, the supply of the first fluid (in this example, water) is stopped. Thus, the risk of the second fluid contaminating, for instance, the restriction 20 is reduced.

FIG. 1c shows a situation when the needle 28 is pierced through a wall of the storage space 8 and the third fluid is supplied under pressure to the second fluid in the storage space. The situation shown occurs at the moment when the control device 34 will stop the supply of hot water to the first mixing chamber, will no longer effect the supply of the third fluid to the second fluid in the storage space, and will effect the retraction of the needle 28 from the respective wall of the storage space so that, thereupon, the holder can be taken from the apparatus again.

After this, a user can remove the exchangeable holder and, if a new amount of beverage is to be prepared, place a new exchangeable holder in the apparatus 4. The new exchangeable holder can be provided with an entirely different type of second fluid such as, for instance, a milk concentrate. When, with the aid of the new exchangeable holder, milk is prepared in a manner comparable to that as described for the preparation of coffee based on coffee concentrate, in the prepared milk, no trace will be found of the previously prepared type of beverage. The fact is that the first mixing chamber forms part of the exchangeable holder and when a new exchangeable holder is placed in the apparatus, also, an entirely new and, hence, clean first mixing chamber is placed in the holder. Therefore, contamination cannot be involved.

On the basis of FIGS. 2a-2c, presently, a second embodiment of the system according to the invention is described. Here, parts in FIG. 2 corresponding to parts in FIG. 1 are provided with the same reference numerals.

An important difference is, as is clearly visible in FIGS. 2b and 2c, that presently, the restriction 20 forms part of the exchangeable holder 2. It can further be seen that the air inlet 42 forms part of the exchangeable holder 2. Here, it holds once more that the air inlet opening is in fluid communication with the first mixing chamber downstream of the restriction. In FIG. 1a it applied that the first mixing chamber was provided with an inlet opening through which extended the fluid flow path 22 to the first mixing chamber. In fact, this inlet opening was formed by the inlet opening 16 of the holder as such. In FIG. 2b, it is shown that the inlet opening 16 of the holder does not form the inlet opening of the first mixing chamber 10. The fact is that the restriction 20 is included downstream of the inlet opening 16. As is clearly visible in FIG. 2b, the exchangeable holder is provided, downstream of the restriction 20 with an elongated channel 46 in which, downstream of the restriction 20, first, the air inlet 42 terminates and, then, the fluid communication 14 of the storage space 8 terminates. The actual first mixing chamber 10 is in fact downstream of the restriction in the channel 46.

Before being used, the holder can be provided, as shown in FIG. 2b, with a closure 17 which seals off the inlet opening 16, which closure may, however, be removed. Such a closure can, for instance, be a removable seal 17. The holder is also provided with a closure sealing off the outflow opening 12, which closure, however, can also be removed. In this example, this closure too is provided with a removable seal 13. These removable seals 13, 17 are removed by a user. Then, the exchangeable holder is placed in the apparatus, as shown in FIG. 2a. Here, the inlet opening 16 is connected to the outflow opening 18 of the fluid dispensing device 6 (in FIG. 2a, this connection has not been realized yet). Also, as shown in FIG. 2a, the storage space 8 will, once more, be placed under the needle 28. Once more, a user pushes the button 36 for starting the preparation of the beverage. Then, the control device 34 provides for the fluid dispensing unit 32 to start moving the needle 28 in the direction of the arrow Pa, while the needle 28 is pierced through a wall of the storage space 8, and for the third fluid to be supplied under pressure to the second fluid in the storage space. Hence, the storage space 8 and the needle 28, combined, form part of a dosing device. Through supply of the third fluid, the pressure in the storage space 8 will increase. As a result, the breakable skin 38 will tear whereupon, upon further supply of the third fluid, the coffee concentrate will be supplied to the first mixing chamber 10 in a dosed manner. The control device 34 also ensures that the fluid dispensing device 6 is started. This will thus start dispensing hot water under pressure. This may be, for instance, at the moment the fluid dispensing device is still activated or some time later, so that the first mixing chamber is first filled with only concentrate, and thereafter also with the hot water. The hot water flows via the outflow opening 18 of the apparatus 4 to the holder 2. Thus, the hot water is supplied under pressure via the inlet opening 16 to the holder 2. In particular, the hot water thus flows along the fluid flow path 22 in the direction of the restriction 20. At the restriction 20, thus, a jet is formed of the hot water. This jet of hot water spouts in the direction of an inside wall 48 of the mixing chamber 10. As the air inlet opening 42 is included downstream of the restriction 20, as a result of a venturi-effect, air will be drawn in via the air inlet opening 42. Together with the jet, the drawn-in air moves in the direction of the inside wall 48. In the first mixing chamber 10, the air and the hot water will come into contact with the concentrate. As the jet impacts on the inside wall 48, swirls are formed in the first mixing chamber, resulting in that air, concentrate and hot water are mixed together, all this comparable to the system according to FIG. 1. The thus formed beverage with the whipped-in air leaves the first mixing chamber via the outflow opening 12. Thus, a coffee extract with a fine bubble froth layer is obtained. When the desired amount of beverage is obtained, the control device 34 stops the fluid dispensing device, and the control device 34 will also provide that the third fluid is no longer supplied to the second fluid in the storage space and that the needle be withdrawn from the respective wall of the storage space so that the used holder can be removed from the apparatus.

The size of the air inlet opening 42 can be completely geared to the type of beverage that is to be prepared. If, in the apparatus, a different holder is placed, with which a different sort of beverage can, for instance, coffee is to be prepared, the air inlet, i.e. the size of the air inlet, can be accordingly adjusted. For preparing a frothed milk based on a milk concentrate, for instance the size of the air inlet 42 can be greater than when coffee extract is to be prepared. For preparing other beverages with which whipping-in air is not desired, the air inlet 42 can be omitted. It is also possible that the air inlet 42 be provided with an adjustable valve 46 that may be adjusted by a user for determining the amount of air that is to be whipped into the beverage. This valve can also, for instance automatically, by adjusted by the apparatus. For instance, in case of FIG. 1, the air inlet 42 can be provided with an adjustable valve 50, schematically represented in the drawing. In order to determine how the valve is to be adjusted for preparing the beverage, the exchangeable holder can be provided with, for instance, a readable code in the form of, for instance, a bar code or a code stored in a responder known per se. The apparatus is provided with a code reading unit 52 which is connected to the control device 34 by means of a signal wire 54. Via the code reading unit 52, the control device 34 reads out a code which indicates, for instance, in what manner the valve 50 is to be set. This code may depend on the type of second fluid stored in the holder 2. If a milk concentrate is concerned, the code may ensure that the valve is opened further than when a coffee concentrate is present. Completely analogously, the apparatus may be designed to also adjust an adjustable valve 50 of the air inlet 42 when this forms part of the holder, as is the case in FIG. 2a. Something similar can therefore in general be used. The fluid dispensing device can also, at will, dispense different sorts of first fluids, such as steam or water. This choice may be determined by the readable code. If the holder is filled with a concentrate, for instance hot water can be dispensed by the fluid dispensing device. However, if the holder is filled with a beverage such as milk, the code of the holder may provide for the fluid dispensing device to dispense steam so that the milk in the first chamber is mixed with the steam for obtaining hot milk.

On the basis of FIGS. 3a and 3b, presently, a third embodiment of a system according to the invention is briefly described. Here, once more, parts corresponding in FIGS. 1 and 2 are provided with the same reference numerals.

The system according to FIG. 3a corresponds, at least substantially, to the system according to FIG. 2a. The difference resides in the form of the first mixing chamber. Here too, a channel 46 is provided which extends from, for instance, the inlet opening 16 to the outflow opening 12. Into this channel 46, which forms part of the earlier mentioned fluid flow path 22, terminates, via the fluid communication 44, the air inlet opening 42. Also, the fluid communication 14 terminates into this channel 46. Downstream of the position 56 where the fluid communication 14 terminates into the channel 46, a first mixing chamber 10 is in fact formed in this channel. In the first mixing chamber 10, a jet impact element 58 is included. The jet impact element 58 is therefore in the first mixing chamber 10 (see FIGS. 3a and 3b). The restriction 20 is directed with respect to the jet impact element 58 such that, in use, the jet generated by the restriction 20 impacts on the jet impact element. Upon impact of the jet on the jet impact element, the liquid is atomized. Simultaneously, by means of the jet, by the air inlet opening 24, air will be drawn in. Also, the concentrate in the dosing device 24 is supplied in a dosed manner to the first mixing chamber 10. In the first mixing chamber, the hot water and the extract are mixed together well. As the jet impact on the jet impact element, the jet is, furthermore, atomized and air can be whipped in well. Thereupon, the thus formed beverage with whipped-in air leaves the first mixing chamber 10 via the outflow opening 12. Here, the beverage can flow around the jet impact element towards the outflow opening 12. The further operation of the apparatus is comparable to what is described on the basis of the preceding figures.

Presently, on the basis of FIGS. 4a and 4b, a fourth embodiment of a system according to the invention is described.

In this example, the holder substantially corresponds to what is described on the basis of FIG. 1. However, it presently holds that the exchangeable holder is provided with a plurality of storage spaces 8a and 8b, in this example two, separated from each other. In this example, this is achieved in that, as shown in FIG. 4a, the storage space 8a is separated from the storage space 8b by means of a partition wall 60. The storage space 8a, 8b thus comprises a circumferential outer wall 62 (see FIG. 4b) which encloses a space which is divided into two parts with the aid of the inside wall 60 (see FIG. 4b).

The storage spaces 8a and 8b form at least a part of the dosing device 24. This dosing device 24 is further provided with a needle 28a which, in use, is pierced through a wall of the storage space 8a for supplying the third fluid to the second fluid in the storage space 8a for dispensing the second fluid to the first mixing chamber in a dosed manner. In this example, the needle 28a is pierced through the wall of the storage space 8a at the second supply location 27′a. The dosing device 24 is further provided with a needle 28b which, in use, is pierced through a wall of the storage space 8b for supplying the third fluid to the second fluid in the storage space 8b for dispensing the second field in a dosed manner to the first mixing chamber. In this example, the needle 28b is pierced through the wall of the storage space 8b at the second supply location 27′ b. The needles 28a and 28b are connected to a fluid dispensing unit 32. This fluid dispensing unit can be a mutually dependent fluid, dispensing unit for the needles 28a and 28b, but can also be an independent fluid dispensing unit for the needles 28a and 28b.

The first storage space 8a terminates, via a first fluid communication 14a, into the first mixing chamber 10. The second storage space 8b terminates, via a fluid communication 14a, in the first mixing chamber 10. The second storage space 8b terminates, via a second fluid communication 14b, into the first mixing chamber 10. The fluid communication 14a comprises a through-flow opening 64a while the fluid communication 14b comprises a through-flow opening 64b (see FIG. 4a). The through-flow opening 64a forms the second entrance opening 23a′ while the through-flow opening 64b forms the second entrance opening 23b′.

It is noted here that, for the sake of clarity, in FIG. 4a, not all reference numerals have been included that have been included in FIG. 2a. The operation of the apparatus is as follows.

Completely analogously to what is described hereinabove, the inlet opening 16 and the outflow opening 12 are released for removing the earlier-mentioned seals. After this, the holder 2 can be placed in the apparatus 4. Here, the inlet opening 16 is fluid-tightly connected to the outlet opening 18. The user starts the process for preparing the beverage by energizing the button 36. As a result, completely analogously to what is described hereinabove, the control device 34 provides for the fluid dispensing device 6 to be started for dispensing the first fluid under pressure, in this example hot water. Thus, with the aid of the restriction 20, a jet is generated that spouts into the first mixing chamber 10. The control device 34 also ensures that the needles 28a and 28b, respectively, are pierced through walls of the storage space 8a and 8b, and the third fluid is supplied to the second fluid in the storage spaces. In this example, the fluid communication 14 is, once more, sealed off by a breakable skin 38a, while the fluid communication 14b is sealed off by a breakable skin 38b. The result of the supply of the third fluid to the storage spaces is that both in the storage space 8a and in the storage space 8b, the pressure starts to increase. Here, for instance the breakable skins 38a, 38b can be constructed in a manner such that first, the breakable skin 38a opens, for instance in that it is of thinner design. If then, for instance, the storage space 8a is filled with a coffee concentrate, in this manner, first, coffee concentrate will be supplied to the first mixing chamber. Hence, first, coffee is formed leaving the mixing chamber via the outflow opening 12. When the storage space 8s is at least virtually empty, so that all the coffee concentrate has disappeared from the storage space 8a and has been used for preparing coffee, the second breakable skin 38b, that may be somewhat thicker than the first breakable skin 38a, will tear open. This means that only when at least virtually all coffee concentrate has been dispensed from the storage space 8a to the first mixing chamber, the fluid from the storage space 8b will be supplied in a dosed manner to the first mixing chamber. The fluid at the storage space 8b can consist of, for instance, milk concentrate. The result is that then, under supply of hot water, milk is generated in the first mixing chamber. Furthermore, as a result of the air inlet opening 42, frothing milk will be created. This frothed milk will then end up on top of the coffee extract already present in the mug 40, while the frothed part of the milk will float on top of this. Thus, a perfect cappuccino is obtained.

Further, other variants are conceivable. For instance, the through-flow opening 64a can be designed to be larger than the through-flow opening 64b. When, for instance, the tearable skins 38a and 38b open at exactly the same pressure, and therefore, in that case, will open virtually simultaneously, upon supply of the third fluid, first, the pressure in the storage spaces 8a and 8b will increase to and equal extent. When, thereupon, the two tearable skins 38a and 38b break approximately simultaneously, via the through-flow opening 64a, coffee concentrate will be supplied from the storage space 8a to the first mixings chamber 10. Simultaneously, milk concentrate will be supplied from the storage space 8b to the first mixing chamber 10. Both concentrates will mix with the jet of the hot water that is supplied by the fluid dispensing device 6 to the first mixing chamber 10. Thus, a beverage is formed consisting of coffee with milk, and which is captured in a mug 40 when the beverage leaves the first mixing chamber 10 via the outflow opening 12. However, as the through-flow opening 64 in this example has a much larger surface than the through-flow opening 64b, the flow rate of the coffee concentrate that is supplied to the first mixing chamber will, initially, be greater than the flow rate of the milk concentrate that is supplied to the first mixing chamber 10. As in this example, the volume of the storage space 8a is approximately equal to the volume of the storage space 8b, the result is that the storage space 8a is empty first. When the storage space 8a is empty, while the storage space 9b is not empty yet, then, only milk concentrate will be supplied to the mixing chamber 10. As a result, only frothed milk will be formed which then ends up on top of the coffee already captured in the mug 40. This frothed milk will, once more, float on the coffee and form an attractive white froth layer. Thus, once more, a cappuccino is formed.

It is also possible that for instance the through-flow opening 64a and the through-flow opening 64b have the same size. It may be so that, for instance, the volume of the storage space 8a is smaller than the volume of the storage space 8b. Here, it may furthermore be effected that the coffee concentrate in the storage space 8a is much stronger, i.e. has a higher concentration than milk concentrate in the storage space 8b. As the through-flow openings 64a, 64b are approximately equally large, initially, the flow rate of the coffee concentrate will be approximately equal to the flow rate of the milk concentrate. Here, it is assumed that both concentrates have the same viscosity. The result is that the storage space 8a will be empty sooner than the storage space 8b. This means that when the storage space 8a is empty, ten, only milk concentrate is supplied from the storage space 8b to the first mixing chamber so that, once more, after, initially, coffee with milk is formed in the mixing chamber, after that, only milk is formed in the first mixing chamber. Thus, once more, a cappuccino is obtained.

It is further also possible that the volume of the storage space 8a and the storage space 8b are equal to each other. Also, for instance the size of the through-flow openings 64a and 64b can be equal to each other. Presently, is has however been effected that the coffee concentrate is less viscous than the milk concentrate. The result is that upon supply of the third fluid, once more, it holds that the flow rate of the coffee concentrate from the storage space 8a is greater than the flow rate of the milk concentrate from the storage space 8b. Here it once more holds that, initially, both coffee concentrate and milk concentrate are supplied to the first mixing chamber 10, so that coffee is formed leaving the first mixing chamber via the outflow opening 12 and ending up in the container 40. When, some time later, the storage space 8a is virtually empty, this will not yet be the case for the storage space 8b with the milk concentrate. The fact was that the milk concentrate was more viscous so that the flow rate was smaller. After this, therefore, at least substantially only milk concentrate will be supplied to the mixing chamber 10 so that at least substantially frothed milk is formed that, once more, ends up on top of the coffee already present in the container 40 so that, once more, a cappuccino is formed. Such variants are all understood to fall within the framework of the invention.

On the basis of FIGS. 5a and 5b, a fifth embodiment of a system according to the invention is discussed. Once more, the system according to FIGS. 5a and 5b corresponds at least substantially to the system of FIG. 1. Here too, only the differences with the system according to FIG. 1 will be briefly elucidated.

With the system according to FIG. 5 too, the exchangeable holder is provided with a plurality, in this example two, of storage space 8a and 8b, separated from each other, which are each filled with a fluid. In this example, the storage space 8a is, once more, filled with a coffee concentrate while the storage space 8b is filled with a milk concentrate. In this example, the storage spaces 8a and 8b are each at least substantially identical to the storage space 8 as discussed on the basis of FIG. 1. Therefore, they are at least virtually completely separated storage spaces, while there is also no joint wall, as was the case with FIG. 4. The needle 82a is connected to a fluid dispensing unit 32a and the needle 28b is connected to a fluid dispensing unit 32b, while the fluid dispensing units 32a and 32b are each similar to the fluid dispensing unit 32 of FIG. 4a.

The storage space 8a terminates, via the fluid communication 14a, into the first mixing chamber 10. Via the fluid communication 14, the storage space 8b terminates into the first mixing chamber 10. It further holds that the fluid communication 14a is sealed off, once more, by a breakable skin 38a while the fluid communication 14b is sealed off by a breakable skin 38b. As can be seen in the drawing, the fluid communications 14a and 14b together terminate in a joint outflow opening 66. An underside of this outflow opening is shown in FIG. 5b. Instead of a breakable skin 38a and 38b, per fluid communication 14a, 14b, also, a breakable skin 38 could be provided for sealing off the joint outflow opening 66. This is, however, not the case in this example.

The fluid dispensing units 32a and 32b are designed for supplying third fluids in an independent manner into the storage space 8a and 8b. With this, the system is, in fact, provided with a dosing device which comprises a plurality of different, independent dosing devices for supplying, with these different dosing devices, in a dosed manner, second fluids from mutually different storage space 8a and 8b to the mixing chamber. The third fluid that is supplied to the first storage space is not necessarily the same as the third fluid that is supplied to the second storage space, but this can be the case.

Thus, it is possible to free the storage spaces 8a and 8b from the second fluids at a mutually different pace and/or during mutually differing periods. For instance, for preparing a beverage, first, the concentrate can be supplied from the storage space 8a to the first mixing chamber and then, the concentrate can be supplied from the storage space 8b to the first mixing chamber. The result is that for instance first, in the first mixing chamber, coffee is formed, and then milk. Here, the air inlet may further comprise the valve 50 mentioned. The code reading unit 52 reads, for instance, the code when the inlet opening 16 and the outflow opening 18 are fluid-tightly interconnected. This code 52 mentioned comprises information relating to the types of fluids with which the first storage space 8a and the second storage space 8b, respectively, are filled, in this example coffee concentrate and milk concentrate, respectively. If the holder is thus intended for the preparation of cappuccino, the control device 34 can determine this on the basis of the read-out code. To this end, when for instance the button 36 is pushed in again, the control device will first supply the third fluid to the storage space 8a by means of the fluid dispensing unit 32a. As a result, first, coffee concentrate will be supplied from the storage space 8a to the mixing chamber 10. Simultaneously, the control device 34 can for instance effect that the air inlet valve 50 is closed. When the air inlet valve 50 is closed and hot water is supplied under pressure to the restriction 20 with the aid of the fluid dispensing device 6 (simultaneously or just after the dosing of the coffee concentrate has started), a jet of water is generated with which no air is drawn along via the air inlet opening 42. The hot water will mix with the coffee extract, while, at least substantially, no air is whipped into the coffee. First, via the outflow opening 12, the coffee extract will be dispensed without this being provided with a fine bubble froth layer. When, after some time, the storage space 9a is at least virtually empty, the control device 34 will ensure that thereupon, the third fluid is supplied to the second storage space 8b. As a result, the second storage space 8b is slowly emptied. Thus, milk concentrate is supplied to the mixing chamber 10. Presently, the control device 34 can ensure that the air regulating valve 50 is opened. As a result, owing to the jet of hot water generated with the aid of the restriction 20, air is drawn into the first mixing chamber. Thus, in the first mixing chamber, milk with whipped-in air is formed. Therefore, this milk comprises a fine bubble froth layer. When, thereupon, the hot milk is supplied via the outflow opening 12 to the coffee extract, the frothed milk will float on the coffee extract so that, once more, a cappuccino is formed. Here, the fluid dispensing device can continue generating hot water when the storage space 8a is empty and, thereupon, the storage space 8b is emptied. The fluid dispensing device can also be temporarily stopped when a switch has to be made from dispensing coffee concentrate to dispensing milk concentrate.

The system to be discussed hereinafter according to FIG. 7 largely corresponds to the system according to FIG. 1. Hereinafter, the differences between the system according to FIG. 1 and the system according to FIG. 7 will be further elucidated.

In FIG. 7 it is shown that the system according to the invention can further be provided with a second mixing chamber 100 forming a fluid communication between the first mixing chamber 10 and the outflow opening 12. The outflow opening 12 is located in a bottom 102 of the second mixing chamber 100. The second mixing chamber 100 forms a part of the exchangeable holder 2.

In this example too it applies that the system is further provided with a restriction 20 which is included in the fluid flow path 21 that extends via the outlet opening 18, the inlet opening 16 and the first mixing chamber 10 (and, in this example, also via the second chamber 100) from the fluid dispensing device 6 to the outflow opening 12. In this example, the restriction 20 is located in a fluid communication 104 between the first mixing chamber 10 and the second mixing chamber 100. The restriction 20 is designed in a manner such that, in use, with the restriction, a jet of the beverage is generated which spouts into the second mixing chamber 100. In this example too, the system is provided with an air inlet opening 42 for supplying air to the beverage in the system.

In this example, the air supply opening 42 terminates, via the fluid communication 44 downstream of the restriction 20 and upstream of the second mixing chamber 100, into the fluid flow path 21 (n this example the fluid communication 104).

The operation of the system is as follows. Completely analogously to what is described at FIG. 1, first, the removable closures will be removed and the holder will be connected to the apparatus. By pushing the button 36, the control device 34 will ensure that the dosing device 24 starts dispensing the second fluid to the first mixing chamber 10. Simultaneously, or soon after, the control device 34 provides for the fluid dispensing device 6 to start dispensing the first fluid under pressure to the first mixing chamber. In the first mixing chamber, the first fluid and the second fluid will mix together so that the beverage is formed. The first mixing chamber 10 will be gradually filled with the beverage. When the first mixing chamber is full, in that the dosing device continues to supply the second fluid under pressure to the first mixing chamber 10 and the fluid dispensing device continues to supply the first fluid under pressure, the pressure in the first mixing chamber will increase so that the beverage is pressed from the restriction 20 out of the first mixing chamber 10. The result is that with the restriction 20, a jet of the beverage is formed which spouts into the second mixing chamber 100. Also, as a result of the venturi effect, air will be drawn in via the air inlet opening 42. This air too flows to the second mixing chamber 100.

In the second mixing chamber 100 the jet will impact on the bottom 102 for whipping in air. The beverage and the air will mix together so that air is whipped into the beverage. The beverage with the whipped-in air then flows from the second mixing chamber 100 via the outflow opening 12 as the beverage with a fine-bubble froth layer.

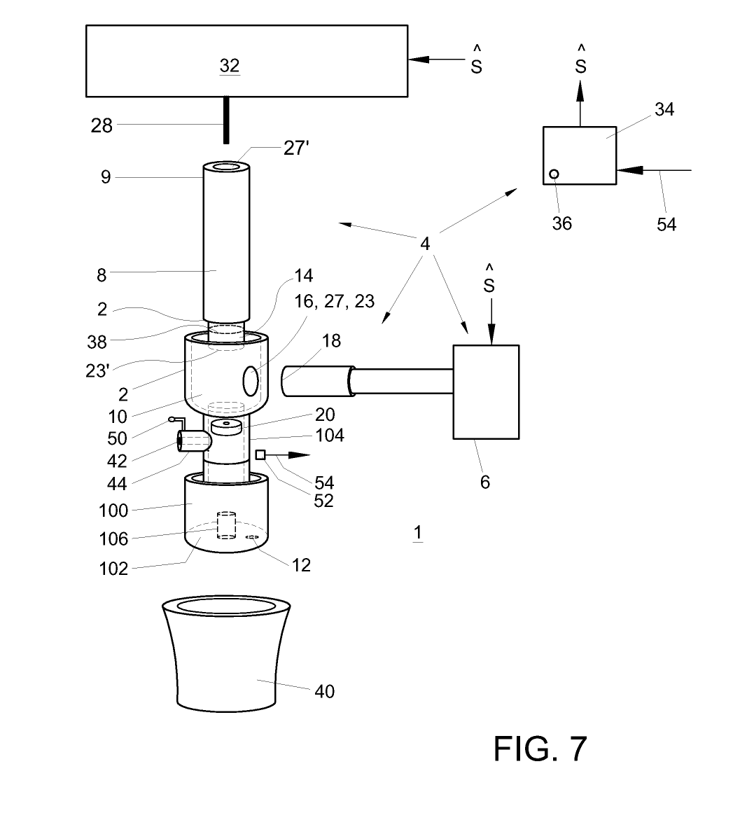

In the second mixing chamber 100, a further jet impact element 106 can be included (shown in interrupted lines in FIG. 10) while the restriction 20 is positioned relative to the jet impact element such that in use, the jet impacts on the impact element for whipping air into the beverage as described with reference to FIG. 3. Completely analogously to what is described hereinabove, when no air needs to be whipped in, the air inlet opening 42 can be closed or be omitted.

It is noted that each of the embodiments according to FIGS. 1-6 can be provided with a second mixing chamber 100 as discussed on the basis of FIG. 7.

Further, with the apparatus according to FIG. 7, the air inlet opening 42 can also positioned as shown in, for instance, FIG. 1. Then, air is drawn in and supplied to the first fluid. Via the first fluid, the air enters the first mixing chamber and will then mix with the beverage obtained there. The jet formed with the restriction 20 will then also comprise air. After impact of the jet in the second mixing chamber, once more, a beverage with a fine bubble froth layer will be formed.

In the examples given hereinabove, with the dosing device, the second fluid can be dispensed under pressure to the first chamber. As a result, in the embodiment according to FIG. 7, the beverage cannot flow back into the storage space 8. It is also conceivable that the dosing device is an active dosing device which dispenses the second fluid by means of a pump.

In each of the outlined embodiments, the first fluid can consist of a gas such as steam. In such a case, the second fluid will often already contain a beverage to which the gas is added in the first mixing chamber 10, for instance for heating the beverage. The gas can also comprise carbon dioxide (CO₂) for obtaining a carbonated beverage. Also, the first fluid can comprise both a liquid and a gas.

In each of the embodiments according to FIGS. 1-7, further, the restriction can be omitted. However, the first and/or second fluid must then be supplied to the first mixing chamber 10 at a sufficiently great flow velocity in order that the first and second fluid will mix together well. Also, according to the invention, the restriction can be designed such that a mist is generated with the restriction. With the variants according to FIGS. 1-6, this entails that a mist of the first fluid is generated in the first chamber. To this end, the restriction can be manufactured from rubber with a through-feed opening whose diameter can vary slightly when the first fluid is supplied, for atomizing the first fluid. The atomized first fluid and the second fluid mix together whereby the beverage with whipped-in air is obtained. The beverage can then leave the first chamber with a fine-bubble froth layer. If the beverage comprises relatively large air bubbles, these can be stopped or broken by adjusting the size of the outflow opening. The large bubbles may for instance not pass the outflow opening so that a beverage with a fine-bubble froth layer is dispensed. With the variant according to FIG. 7, this entails that a mist of the beverage is generated in the second chamber 100. As a result, air is whipped into the beverage. The beverage can then leave the second chamber with air whipped in. The beverage can then flow via the outflow opening from the holder with a fine-bubble froth layer as described hereinabove.

In the embodiments outlined hereinabove, the first fluid is supplied to the first mixing chamber during at least a first period and the second fluid is supplied to the first mixing chamber during at least a second period.

Here, the first and second period may start at the same time and end at the same time. It is also possible that the second period starts sooner than the first period. However, other variations are possible too.

Further, the fluid dispensing device 6 can be designed to dispense, at wish, (Efferent types of first fluids, such as steam, water, CO₂ etc. Once more, the selection hereof can be controlled by the control unit 34 and will often coincide with the type of second fluid or second fluids in the exchangeable holder. Also, if desired, this choice can be set manually or be determined with the aid of the code reading unit 52.

The invention is not limited in any manner to the embodiments outlined hereinabove. In the embodiment according to FIG. 4, the storage spaces are located next to each other. It is also possible that the storage spaces lie one above the other as schematically shown in FIGS. 6a and 6b. With the embodiment of FIG. 5a, the restriction and the air inlet opening belong to the holder, this in contrast to what is the case in FIG. 1. Naturally, also in FIG. 5a, the restriction and/or the air inlet can be fixedly connected to the apparatus. The second fluids are for instance mixable and/or dissolvable in the first fluid. In the example, the storage space mentioned were filled with coffee concentrate and/or milk concentrate. Other fluid, based or not based on concentrate, are also conceivable, here, for instance a syrup or powder for preparing a lemonade can be involved. The apparatus can also be further provided with additional storage spaces that may be filled with additives such as for instance soluble powders or concentrates. These powders too can be supplied to the first mixing chamber through urging with the aid of a third fluid, or by squeezing the respective storage space empty. Here, for instance, flavour enhancers, sugars, cocoa and the like can be involved. Also, milk powder and/or milk creamer can be involved. Generally, it holds that instead of a concentrate, the second fluid can also a powder and the like, soluble in the first fluid or mixable with the first fluid, for instance soluble in a liquid such as water. Also, a second fluid in the storage space can comprise both a concentrate and a powder in mixed form or not in mixed form.

Such variants are all understood to fall within the framework of the invention. The temperature of the first fluid can vary. For instance, the first fluid can also consist of water at room temperature or cold water. Also, the temperature of the first fluid that is supplied to the holder for preparing a beverage can vary over time. Instead of tearable skins, the seals 38 can also comprise valves known per se that are operated by the apparatus for opening. The closure 17 can also be designed differently than a removable seal. For instance, the closure can be provided with a valve which can be manually operated or by the apparatus. The closure can also be formed by a tearable skin that tears open under the influence of a mixture of fluid and liquid in the mixing chamber. In the above-mentioned examples, the needle was directly pierced into the wall of the respective storage space. However, generally, it is also possible that the needle is pierced into a wall of the holder at a position below which there is a space which is in fluid communication with the storage space. If the holder is provided with several storage spaces one needle can be pierced in the holder for supplying the third fluid to the second fluids in the several storage spaces. Then, the needle is pierced into a wall of the holder at a position under which there is a space which is in fluid communication with the storage spaces. However, it is also possible that per storage space, a needle is pierced into a wall of the holder. This may be in a wall of the respective storage spaces themselves, or in a wail of the holder at positions below which there are several spaces which, respectively, are in fluid communication with the different storage spaces.

In the preceding examples, the needle was pierced in the holder through activation of the dosing device by pushing the button. However, it is also possible that the needle is manually pierced into the holder. The needle may be attached to a lid of the apparatus. Then, the apparatus is provided with a receiving space for the holder, which can be dosed off by the lid. By closing the receiving space with the lid, the (at least one) needle can be pierced into the holder.

The volume of a storage space can vary from, for instance, 5 to 150 millilitres, more specifically from 6 to 50 millilitres. A passage opening of the restriction can vary from, for instance, 0.4 to 1.5 mm, more particularly from 0.6 to 1.3 mm, still more particularly from 0.7 to 0.9 mm. The pressure at which, in use, the liquid dispensing device dispenses the first fluid can vary from 0.6 to 12 bars, more particularly from 0.7 to 2 bar and preferably from 0.9 to 1.5 bars. The period during which, for the preparation of the beverage, the first fluid is supplied to the first mixing chamber can vary from 2 to 90 seconds, more particularly from 10 to 50 seconds. The size of the air inlet opening can vary, if this is completely opened, from, for instance, 0.005 to 0.5 mm².

1. A system for preparing a predetermined amount of beverage suitable for consumption, the system comprising:
an exchangeable holder, and
an apparatus having a fluid dispensing device which is detachably connected to the holder for dispensing at least an amount of at least a first fluid, such as a liquid and/or a gas, in particular such as water and/or steam, under pressure, to the exchangeable holder,
the exchangeable holder comprises:
at least one storage space which is filled with a second fluid, such as a concentrate,
at least a first mixing chamber,
at least one outflow opening which is in fluid communication with the first mixing chamber, for dispensing the beverage from the first mixing chamber,
at least one fluid communication between the storage space and the first mixing chamber for dispensing the second fluid to the first mixing chamber, and
at least one inlet opening which is detachably connected to an outlet opening of the fluid dispensing device for supplying the first fluid to the first mixing chamber,
a dosing device which is designed for supplying the second fluid in a dosed manner from the storage space to the first mixing chamber through supply of a third fluid, such as a gas or a liquid, in a controllable manner, under pressure, to the second fluid in the storage space,
wherein the fluid dispensing device being designed for supplying the first fluid under pressure to the first mixing chamber so that, in the first mixing chamber, the first fluid and the second fluid mix together for obtaining the beverage which then leaves the exchangeable holder via the outflow opening.

2. A system according to claim 1, wherein the dosing device is designed for supplying the second fluid in a dosed manner from the storage space to the first mixing chamber by means of pressurizing the second fluid with the pressure of the third fluid.

3. A system according to claim 1, wherein the third fluid is a gas.

4. A system according to claim 1, wherein the third fluid is a liquid, in particular a liquid with a specific weight that is lower than that of the second fluid.

5. A system according to claim 1, wherein the holder comprises a first supply location and a second supply location located at a distance from the first supply location, while in use, the first fluid is supplied to the holder at the first supply location and the third fluid is supplied to the holder at the second supply location.

6. A system according to claim 5, wherein the inlet opening is located at the first supply location.

7. A system according to claim 5, wherein the second supply location is, or can be brought in fluid communication with the storage space.

8. A system according to claim 1, wherein the first mixing chamber comprises a first entrance opening and a second entrance opening placed at a distance from the first entrance opening, while, in use, the first fluid enters the first mixing chamber via the first entrance opening and the second fluid enters the first mixing chamber via the second entrance opening.

9. A system according to claim 8, wherein the inlet opening is in fluid communication with the first entrance opening and that the fluid communication terminates into the second entrance opening.

10. A system according to claim 1, wherein the dosing device is provided with a needle which, in use, is pierced through a wall of a holder, more particularly through a wall of the storage space or through a wall of the holder at a position below which there is a space which is in fluid communication with the storage space, for supplying the third fluid to the second fluid in the storage space.

11. A system according to claim 1, further comprising a control device for controlling the dosing device and the fluid dispensing device.

12. A system according to claim 1, wherein the fluid dispensing device and the dosing device, independently of each other, can supply the first fluid and the second fluid, respectively, to the first mixing chamber.

13. A system according to claim 1, further comprising a restriction which is included in a fluid flow path which extends, via the outlet opening of the fluid dispensing device, the inlet opening of the holder and the first mixing chamber, from the fluid dispensing device to the outflow opening.

14. A system according to claim 1, further comprising a restriction which is included in a fluid flow path which extends, via the outlet opening and the inlet opening, from the fluid dispensing device to the first mixing chamber.

15. A system according to claim 14, wherein the restriction is designed such that, in use, with the restriction, a jet of the first fluid is generated which spouts into the first mixing chamber.

16. A system according to claim 14, wherein the restriction is designed such that, in use, with the restriction, a mist is generated which flows into the first mixing chamber.

17. A system according to claim 15, wherein the dosing device supplies the second fluid, in a dosed manner, from the storage space to the first mixing chamber while the fluid dispensing device supplies the first fluid under pressure to the fluid flow path.

18. A system according to claim 1, further comprising a second mixing chamber which forms a fluid communication between the first mixing chamber and the outflow opening.

19. A system according to claim 13, wherein the restriction is included between the first mixing chamber and the second mixing chamber.

20. A system according to claim 18, wherein the restriction is designed such that, in use, with the restriction, a jet of the beverage is generated which spouts into the second mixing chamber.

21. A system according to claim 19, wherein the restriction is designed such that, in use, with the restriction, a mist of the beverage is generated which flows into the second mixing chamber.

22. A system according to claim 1, further comprising at least one air inlet opening for supplying air to the beverage in the system.

23. A system according to claim 1, further comprising at least one air inlet opening for supplying air to the first mixing chamber so that, in use, air is whipped into the beverage for obtaining a beverage with a fine bubble froth layer.

24. A system according to claim 23, further comprising a restriction which is included in a fluid flow path which extends, via the outlet opening and the inlet opening, from the fluid dispensing device to the first mixing chamber, wherein the at least one air inlet opening is in fluid communication with the first mixing chamber downstream of the restriction.

25. A system according to claim 23, wherein the at least one air inlet opening, via a fluid communication, terminates into the fluid flow path.

26. A system according to claim 22, further comprising a second mixing chamber which forms a fluid communication between the first mixing chamber and the outflow opening, wherein the system is provided with the at least one air inlet opening for supplying air to the second mixing chamber.

27. A system according to claim 22, wherein the at least one air inlet opening forms part of the holder.

28. A system according to claim 22, wherein the at least one air inlet opening forms part of the apparatus.

29. A system according to claim 13, wherein the restriction forms part of the holder.

30. A system according to claim 13, wherein the restriction forms part of the apparatus.

31. A system according to claim 1, wherein between the storage space and the first mixing chamber, a closure is present that will open when the pressure applied by the second fluid to the closure increases to above a predetermined value.

32. A system according to claim 1, wherein the exchangeable holder is provided with a plurality of storage spaces, separated from each other, which are each filled with a second fluid.

33. A system according to claim 32, wherein the holder is provided with a plurality of fluid communications which each form a fluid communication between one of the storage spaces and the first mixing chamber.

34. A system according to claim 32, wherein between each storage space on the one side and the first mixing chamber on the other side, a closure is present which will open when the pressure which is applied by one of the fluids increases to above a determined value.

35. A system according to claim 34, wherein at least a number of the closures will open at mutually different pressures.

36. A system according to claim 32, wherein at two storage spaces are filled with second fluids having a mutually different viscosity.

37. A system according to claim 32, wherein the dosing device is designed for supplying the second fluids in a dosed manner from the storage spaces to the first mixing chamber through supply of third fluids, in a controllable manner, under pressure, to the second fluids in the storage spaces for dispensing the second fluids in a dosed manner to the first mixing chamber from the different storage spaces.

38. A system according to claim 37, wherein the dosing device is designed for supplying the second fluids in a dosed manner from the storage spaces to the first mixing chamber by means of pressurizing the second fluids with the pressure of the third fluids.

39. A system according to claim 36, wherein each fluid communication, via a through-flow opening, forms a communication between one of the storage spaces and the first mixing chamber, while the size of a number of the through-flow openings are selected to be mutually different, for instance for dispensing the fluids from the different storage spaces at mutually different flow rates with the aid of the actuator.

40. A system according to claim 36, wherein the dosing device is designed for supplying the third fluid to the second fluids in the storage spaces, independently per storage space.

41. A system according to claim 32, wherein the system is designed for dispensing fluids from at least two storage spaces at mutually different flow rates and/or during mutually different periods of time.

42. A system according to claim 22, wherein the at least one air inlet opening is provided with an adjustable valve for adjusting the size of the air flow.

43. A system according to claim 1, wherein the holder is provided with a code and the apparatus is provided with a code reading unit for reading the code and a control device which controls the apparatus depending on the code read.

44. A system according to claim 43, wherein, depending on the code read by the code reading unit, the control device controls the liquid dispensing device for determining the pressure, the amount and/or the temperature of the liquid which, in use, is supplied to the holder.

45. A system according to claim 43, wherein the holder is provided with a code and the apparatus is provided with a code reading unit for reading the code and a control device which controls the apparatus depending on the code read, and wherein, depending on the code read, the control device controls the valve.

46. A system according to claim 15, wherein the first mixing chamber is provided with an inside wall wherein the restriction is positioned relative to the inside wall such that, in use, the jet spouts against the inside wall.

47. A system according to claim 15, wherein in the first mixing chamber a jet impact element is included wherein the restriction is positioned relative to the jet impact element such that, in use, the jet impacts on the jet impact element.

48. A system according to claim 1, wherein in an inside wall of the first mixing chamber, an opening is present which provides the first mixing chamber with a fluid communication with the outflow opening.

49. A system according to claim 20, wherein the second mixing chamber is provided with an inside wall, while the restriction is positioned relative to the inside wall such that, in use, the jet spouts against the inside wall.

50. A system according to claim 20, wherein in the second mixing chamber, a jet impact element is included, while the restriction is positioned relative to the jet impact element such that, in use, the jet impacts on the jet impact element.

51. A system according to claim 1, wherein the fluid dispensing device is detachably connected to the holder for dispensing at least an amount of at least one liquid, such as water, under pressure to the exchangeable holder, while the outflow opening is in fluid communication with the first mixing chamber for dispensing the beverage from the first mixing chamber, the system further being provided with a restriction which is included in a fluid flow path which forms a liquid flow path and which extends, via the outlet opening of the fluid dispensing device and the inlet opening of the holder, from the fluid dispensing device to the first mixing chamber, the dosing device being designed for supplying the second fluid in a dosed manner from the storage space to the first mixing chamber while the fluid dispensing device supplies the liquid under pressure to the liquid flow path so that, with the restriction, a jet of the liquid is generated which spouts into the first mixing chamber, while, in the first mixing chamber, the second fluid and the liquid mix together for obtaining the beverage which then leaves the first mixing chamber via the outflow opening.

52. A system according to claim 1, while excluding the system according to claim 51.

53. A system according to claim 1, wherein the dosing device is provided with at least one fluid dispensing unit for supplying the third fluid under pressure to the second fluid in the at least one storage space.

54. A system according to claim 53, wherein the fluid dispensing unit is detachably connectable to the holder.

55. A system according to claim 53, wherein the fluid dispensing unit forms part of the apparatus.

56. A system according to claim 53, further comprising a control device for controlling the dosing device and the fluid dispensing device, and wherein the control device is designed for controlling the fluid dispensing unit.

57. A system according to claim 1, further comprising a control device for controlling the dosing device and the fluid dispensing device, and wherein the control device forms part of the apparatus.

58. A system according to claim 1, wherein the apparatus comprises means cooperating with the holder for supply, with the apparatus, of a third fluid, in a controllable manner, under pressure, to the second fluid in the storage space.

59. A system according to claim 58, wherein the means cooperating with the holder comprise a needle for, in use, piercing through a wall of the holder, more particularly through a wall of the storage space for supplying the third fluid to the second fluid in the storage space.

60. A system according to claim 59, wherein the needle forms part of the apparatus.

61. A system according to claim 53, wherein the dosing device is designed for supplying the third fluid to the second fluids in the storage spaces, independently per storage space, and wherein the fluid dispensing unit is a joint fluid dispensing unit for the different storage spaces for supplying the third fluid under pressure to the different storage spaces.

62. A system according to, claim 53, wherein the dosing device is designed for supplying the third fluid to the second fluids in the storage spaces, independently per storage space, and wherein the dosing device is provided with different respective fluid dispensing units for supplying the third fluid under pressure to the different respective storage spaces.

63. An exchangeable holder designed to be connected to an apparatus provided with a fluid dispensing device for dispensing under pressure at least one first fluid, such as gas and/or liquid, to the exchangeable holder for preparing a beverage suitable for consumption, the exchangeable holder comprises:
at least one storage space which is filled with a second fluid, such as a concentrate,
at least a first mixing chamber,
at least one outflow opening which is in fluid communication with the first mixing chamber for dispensing the beverage from the first mixing chamber,
at least one fluid communication between the storage space and the first mixing chamber for dispensing the second fluid to the first mixing chamber, and
at least one inlet opening which, in use, is detachably connected to an outlet opening of the fluid dispensing device for supplying the first fluid to the first mixing chamber, while the storage space forms part, at least partly, of a dosing device,
wherein the holder being designed such that, in use, with the apparatus, a third fluid can be supplied, in a controllable manner, under pressure, to the second fluid in the storage space for dispensing the second fluid in a dosed manner from the storage space to the first mixing chamber while, in use, the first fluid is also supplied under pressure to the first mixing chamber so that the second fluid and the first fluid mix together for obtaining the beverage which then leaves the holder via the outflow opening.

64. An exchangeable holder according to claim 63, wherein the holder is designed such that, in use, the second fluid can be supplied in a dosed manner from the storage space to the first mixing chamber by means of pressurizing the second fluid with the pressure of the third fluid.

65. An exchangeable holder according to claim 63, wherein the holder comprises a first supply location and a second supply location located at a distance from the first supply location, wherein, in use, the first fluid is supplied to the holder at the first supply location and the third fluid is supplied to the holder at the second supply location.

66. An exchangeable holder according to claim 65, wherein the inlet opening is located at the first supply location.

67. An exchangeable holder according to claim 65, wherein the second supply location is, or can be brought in fluid communication with the storage space.

68. An exchangeable holder according to claim 63, wherein the first mixing chamber comprises a first entrance opening and a second entrance opening placed at a distance from the first entrance opening, while, in use, the first fluid enters the first mixing chamber via the first entrance opening and the second fluid enters the first mixing chamber via the second entrance opening.

69. An exchangeable holder according to claim 68, wherein the inlet opening is in fluid communication with the first entrance opening and that the fluid communication terminates into the second entrance opening.

70. An exchangeable holder according to claim 63, further comprising means cooperating with the apparatus for supplying, in use, with the apparatus, the third fluid to the second fluid in the storage space while for instance the means cooperating with the apparatus comprise at least one locally weakened area of a wall of the holder, more particularly of a wall of the storage space or of a wall of the holder at a position below which there is a space which is in fluid communication with the storage space for, in use, piercing this area with a needle of the dosing device for supplying the third fluid to the second fluid in the storage space.

71. An exchangeable holder according to claim 63, further comprising a restriction which is included in a fluid flow path which extends from the inlet opening of the holder to the outflow opening.

72. An exchangeable holder according to claim 63, further comprising a restriction which is included in a fluid flow path extending form the inlet opening to the first mixing chamber.

73. An exchangeable holder according to claim 72, wherein the restriction is designed such that, in use, with the restriction, a jet of the first fluid is generated which spouts into the first mixing chamber.

74. An exchangeable holder according to claim 72, wherein the restriction is designed such that, in use, with the restriction, a mist of the first fluid is generated which flows into the first mixing chamber.

75. An exchangeable holder according to claim 63, further comprising a second mixing chamber which forms a fluid communication between the first mixing chamber and the outflow opening.

76. An exchangeable holder according to claim 75, wherein the restriction is included between the first mixing chamber and the second mixing chamber.

77. An exchangeable holder according to claim 76, wherein the restriction is designed in a manner such that, in use, with the restriction, a jet of the beverage is generated which spouts into the second mixing chamber.

78. An exchangeable holder according to claim 76, wherein the restriction is designed in a manner such that, in use, with the restriction, a mist of the beverage is generated which flows into the second mixing chamber.

79. An exchangeable holder according to claim 63, further comprising at least one air inlet opening for supplying air to the beverage in the holder.

80. An exchangeable holder according to claim 63, further comprising at least one air inlet opening for supplying air to the first mixing chamber so that, in use, air is whipped into the beverage for obtaining a beverage with a fine bubble froth layer.

81. An exchangeable holder according to claim 80, wherein the at least one air inlet opening is in fluid communication with the first mixing chamber.

82. An example according to claim 80, wherein the at least one air inlet opening terminates via a fluid communication into the fluid flow path downstream of the restriction.

83. An exchangeable holder according to claim 79, further comprising at least one air inlet opening for supplying air to the second mixing chamber.

84. An exchangeable holder according to claim 63, wherein between the storage space and the first mixing chamber, a closure is present which will open when the pressure which is applied by the second fluid on the closure increases above a predetermined value.

85. An exchangeable holder according to claim 63, further comprising a plurality of storage space, separated from each other, which are each filled with a second fluid.

86. An exchangeable holder according to claim 85, further comprising means cooperating with the apparatus for supplying, with the apparatus, a third fluid, in a controllable manner, under pressure, to the second fluid in the storage space.

87. An exchangeable holder according to claim 84, further comprising a plurality of fluid communications which each form a fluid communication between one of the storage spaces and the first mixing chamber.

88. An exchangeable holder according to claim 84, wherein between each storage space on the one side and the first mixing chamber on the other side, a closure is present which will open when the pressure which is applied by one of the fluids to the closure increases to above a particular value.

89. An exchangeable holder according to claim 88, wherein at least a number of the closures will open at mutually different pressures.

90. An exchangeable holder according to claim 84, wherein at least two storage spaces are filled with fluids having a mutually different viscosity.

91. A system according to claim 87, wherein each fluid communication, via a through-flow opening, forms a communication between one of the storage spaces and the first mixing chamber, while the size of the number of the through-flow openings are chosen to be mutually different, for instance for dispensing the fluids from the different storage spaces at mutually different flow rates with the aid of the actuator.

92. An exchangeable holder according to claim 84, wherein the holder is designed for dispensing fluids from at least two storage spaces at mutually different flow rates and/or during mutually different periods.

93. An exchangeable holder according to claim 78, wherein the at least one air inlet opening is provided with an adjustable valve for adjusting the size of the air stream.

94. An exchangeable holder according to claim 63, wherein the holder is provided with a code that can be read with a code reading unit.

95. An exchangeable holder according to claim 63, wherein the first mixing chamber is provided with an inside wall, while the restriction is positioned relative to the inside wall such that, in use, the jet spouts against the inside wall

96. An exchangeable holder according to claim 72, wherein in the first mixing chamber, a jet impact element is included while the restriction is positioned relative to the jet impact element such that, in use, the jet impacts on the jet impact element.

97. An exchangeable holder according to claim 63, wherein in an inside wall of the first mixing chamber an opening is present providing the first mixing chamber with a fluid communication with the outflow opening.

98. An exchangeable holder according to claim 76, wherein the second mixing chamber is provided with an inside wall, while the restriction is provided relative to the inside wall such that, in use, the jet spouts against the inside wall.

99. An exchangeable holder according to claim 76, wherein in the second mixing chamber, a jet impact element is included, while the restriction is positioned relative to the jet impact element such that, in use, the jet impacts on the jet impact element.

100. An exchangeable holder according to claim 63, wherein the inlet opening is provided with a removable closure such as a seal.

101. An exchangeable holder according to claim 63, wherein the outflow opening is provided with a removable closure such as a seal.

102. An exchangeable holder according to claim 63, wherein the fluid dispensing device is designed for dispensing a first fluid in the form of a liquid under pressure to the holder while the outflow opening is in fluid communication with the first mixing chamber for dispensing the beverage from the first mixing chamber, while, in use, the liquid under pressure is also supplied to the mixing chamber so that the second fluid and the liquid mix together for obtaining a beverage which then leaves the mixing chamber via the outflow opening.

103. An exchangeable holder according to claim 63, excluding the holder according to claim 102.

104. An exchangeable holder according to claim 63, wherein the storage space has walls that are at least partly flexible, but not stretchable.

105. An apparatus for use in a system according to claim 62.

106. A method for preparing a predetermined amount of beverage suitable for consumption, using an exchangeable holder having at least one storage space which is filled with a second fluid, at least a first mixing chamber, at least one outflow opening which is in fluid communication with the first mixing chamber for dispensing the beverage from the first mixing chamber, at least one fluid communication between the storage space and the first mixing chamber for dispensing the second fluid to the first mixing chamber, and at least one inlet opening, comprising
supplying at least an amount of at least one first fluid, such as a liquid and/or a gas, in particular such as water and/or steam, under pressure to the first mixing chamber of the exchangeable holder,
supplying the second fluid in a dosed manner from the storage space to the first mixing chamber, so that in the first mixing chamber, the first fluid and the second fluid mix together for obtaining the beverage which then leaves the exchangeable holder via the outflow opening.

107. A method according to claim 106, comprising:
detachably connecting the holder to an apparatus, wherein the apparatus is provided with a fluid dispensing device with an outlet opening which is detachably connected to the at least one inlet opening of the holder for dispensing the first fluid under pressure to the first mixing chamber.

108. A method according to claim 107, wherein the apparatus also comprises a dosing device which is designed for supplying a third fluid, such as a gas or a liquid, in a controllable manner, under pressure, to the second fluid in the storage space for supplying the second fluid in a dosed manner from the storage space to the first mixing chamber.

109. A method according to claim 108, further comprising pressurizing the second fluid with the pressure of the third fluid for supplying the second fluid in a dosed manner from the first storage space to the first mixing chamber.
